(19) United States
(12) Patent Application Publication
(10) Pub. No.: US 2021/0252434 A1
(43) Pub. Date: Aug. 19, 2021

(54) FILTER CARTRIDGE WITH AIR VENTING FLOW PATH

(71) Applicant: A.L. FILTER EAD, Ruse (BG)

(72) Inventor: Huiying Chen, Shanghai (CN)

(73) Assignee: A.L. FILTER EAD, Ruse (BG)

(21) Appl. No.: 16/794,635

(22) Filed: Feb. 19, 2020

(51) Int. Cl. B01D 29/15; B01D 35/00; B01D 27/08; F02M 37/54

(52) U.S. Cl. CPC B01D 29/15; F02M 37/54; B01D 27/08; B01D 35/005

(57) ABSTRACT

A filter cartridge including a cartridge housing arranged about an axis and including first and second housing end caps and an apertured generally cylindrical housing body joined at opposite ends thereof to the first and second housing end caps, filter material arranged in an accordion-like filter medium disposed within the cartridge housing in a generally cylindrical configuration about a central bore, first and second filter medium end caps attached to opposite ends of the filter medium, a generally cylindrical internal structural member joined to the first filter medium end cap and extending through the central bore and an elongate air venting tube mounted onto the first and second filter medium end caps and extending axially interiorly of the cartridge housing but radially exteriorly of the filter material.

### FIELD OF THE INVENTION

The present invention relates to fluid filters generally and more particularly to fuel filters for vehicles.

### BACKGROUND OF THE INVENTION

Various type of fuel filters for vehicles are known in the art. One example of a fuel filter is described and claimed in U.S. Pat. No. 7,147,110, the description of which is hereby incorporated by reference.

### SUMMARY OF THE INVENTION

The present invention seeks to provide an improved fuel filter of the general type described in U.S. Pat. No. 7,147,110, but significantly different in various aspects from that claimed in U.S. Pat. No. 7,147,110.

There is thus provided in accordance with a preferred embodiment of the present invention a filter cartridge including a cartridge housing arranged about an axis and including first and second housing end caps and an apertured generally cylindrical housing body joined at opposite ends thereof to the first and second housing end caps, filter material arranged in an accordion-like filter medium disposed within the cartridge housing in a generally cylindrical configuration about a central bore, first and second filter medium end caps attached to opposite ends of the filter medium, a generally cylindrical internal structural member joined to the first filter medium end cap and extending through the central bore and an elongate air venting tube mounted onto the first and second filter medium end caps and extending axially interiorly of the cartridge housing but radially exteriorly of the filter material.

In accordance with a preferred embodiment of the present invention the accordion-like filter medium defines an outer circumference and an inner circumference and the elongate air venting tube is located radially exteriorly of the filter material, between two adjacent folds of the accordion-like filter medium and between the outer circumference and the inner circumference. Additionally or alternatively, the elongate air venting tube is located downstream of the filter material along a fuel flow path therethrough.

Preferably, the generally cylindrical internal structural member defines a fuel flow path and the filter cartridge also includes a first gasket providing sealing of the fuel flow path and a second gasket, separate from the first gasket, providing sealing of an air venting flow path.

There is also provided in accordance with another preferred embodiment of the present invention a filter cartridge including a cartridge housing arranged about an axis and including first and second housing end caps and an apertured generally cylindrical housing body joined at opposite ends thereof to the first and second housing end caps, an accordion-like filter medium disposed within the cartridge housing in a generally cylindrical configuration about a central bore, first and second filter medium end caps attached to opposite ends of the filter medium, a generally cylindrical internal structural member joined to the first filter medium end cap and extending through the central bore, the generally cylindrical internal structural member defining a fuel flow path; a first gasket providing sealing of the fuel flow path and a second gasket, separate from the first gasket, providing sealing of an air venting flow path.

In accordance with a preferred embodiment of the present invention the generally cylindrical internal structural member includes a base portion including a circular recess formed therein and the circular recess accommodates the first gasket. Additionally or alternatively, the second housing end cap defines a recess and the second gasket is seated in the recess defined in the second housing.

Preferably, the first gasket is positioned between the generally cylindrical internal structural member and the second filter medium end cap. Additionally or alternatively, the second gasket is positioned between the second filter medium end cap and the second housing end cap.

There is further provided in accordance with yet another preferred embodiment of the present invention a filter cartridge including a cartridge housing arranged about an axis and including first and second housing end caps and an apertured generally cylindrical housing body joined at opposite ends thereof to the first and second housing end caps, filter material arranged in an accordion-like filter medium disposed within the cartridge housing in a generally cylindrical configuration about a central bore, first and second filter medium end caps attached to opposite ends of the filter medium, a generally cylindrical internal structural member joined to the first filter medium end cap and extending through the central bore, the generally cylindrical internal structural member defining a fuel flow path, an elongate air venting tube mounted onto the first and second filter medium end caps and extending axially interiorly of the cartridge housing but radially exteriorly of the filter material, a first gasket providing sealing of the fuel flow path and a second gasket, separate from the first gasket, providing sealing of an air venting flow path coupled to the elongate air venting tube.

Preferably, the accordion-like filter medium defines an outer circumference and an inner circumference and the elongate air venting tube is located radially exteriorly of the filter material, between two adjacent folds of the accordion-like filter medium and between the outer circumference and the inner circumference. Additionally or alternatively, the elongate air venting tube is located downstream of the filter material along a fuel flow path therethrough.

In accordance with a preferred embodiment of the present invention the generally cylindrical internal structural member includes a base portion including a circular recess formed therein and the circular recess accommodates the first gasket. Additionally or alternatively, the second housing end cap defines a recess and the second gasket is seated in the recess defined in the second housing.

In accordance with a preferred embodiment of the present invention the first gasket is positioned between the generally cylindrical internal structural member and the second filter medium end cap. Additionally or alternatively, the second gasket is positioned between the second filter medium end cap and the second housing end cap.

### BRIEF DESCRIPTION OF THE DRAWINGS

The present invention will be understood and appreciated more fully from the following detailed description in which:

FIG. 1 is a simplified side view illustration of a filter cartridge constructed and operative in accordance with a preferred embodiment of the present invention;

FIG. 2 is a simplified sectional view illustration of the filter cartridge of FIG. 1, taken along lines II-II in FIG. 1;

FIG. 3 is a simplified exploded view illustration of the filter cartridge of FIG. 1;

FIGS. 4A and 4B are respective top and bottom-facing simplified pictorial view illustrations of a first housing end cap, forming part of the filter cartridge of FIGS. 1-3;

FIG. 5 is a simplified pictorial view illustration of a generally cylindrical internal structural member joined to a first filter medium end cap and extending through a central bore of the filter cartridge of FIGS. 1-3;

FIG. 6 is a simplified sectional illustration of the location of the axial air venting tube with respect to the folds of the filter medium, FIG. 6 being taken along lines VI-VI in FIG. 1;

FIG. 7 is a simplified pictorial view illustration of an apertured generally cylindrical housing body sealingly joined at opposite ends thereof to the first and second housing end caps;

FIGS. 8A and 8B are simplified respective bottom and top view illustrations of a second filter medium end cap forming part of the filter cartridge of FIGS. 1-3;

FIGS. 9A and 9B are respective top and bottom-facing simplified pictorial view illustrations of a second housing end cap, forming part of the filter cartridge of FIGS. 1-3;

FIG. 10 is a simplified pictorial illustration of a first gasket, providing sealing between the generally cylindrical internal structure and the second filter medium end cap;

FIG. 11 is a simplified pictorial illustration of a second gasket, providing sealing between the second filter medium end cap and the second housing cap;

FIG. 12 is a simplified sectional illustration, corresponding generally to FIG. 2 and showing fuel flow through the filter cartridge of FIGS. 1-3 in accordance with a preferred embodiment of the present invention; and

FIG. 13 is a simplified sectional illustration, corresponding generally to FIG. 2 and showing air flow through the filter cartridge of FIGS. 1-3 in accordance with a preferred embodiment of the present invention.

### DETAILED DESCRIPTION OF A PREFERRED EMBODIMENT

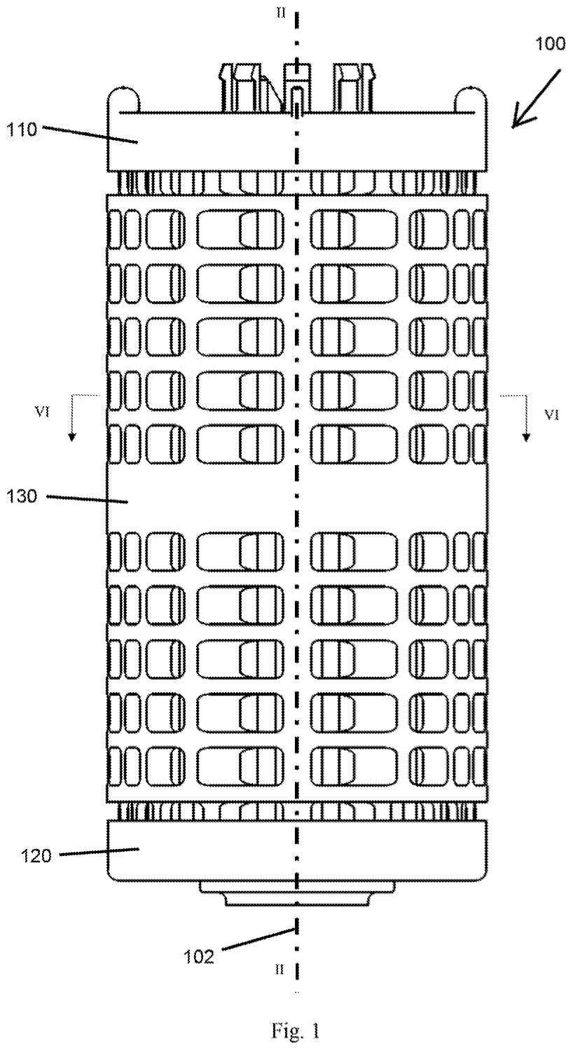

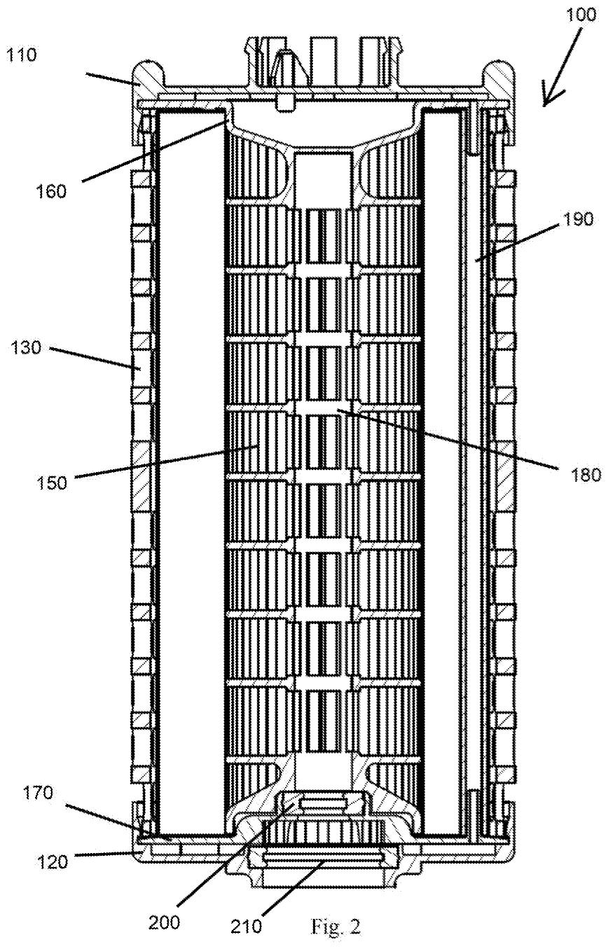

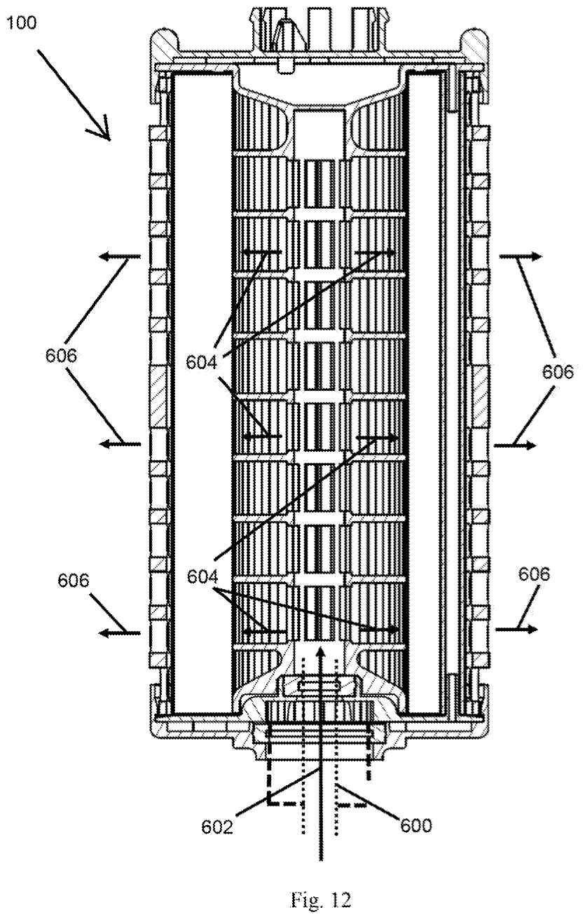

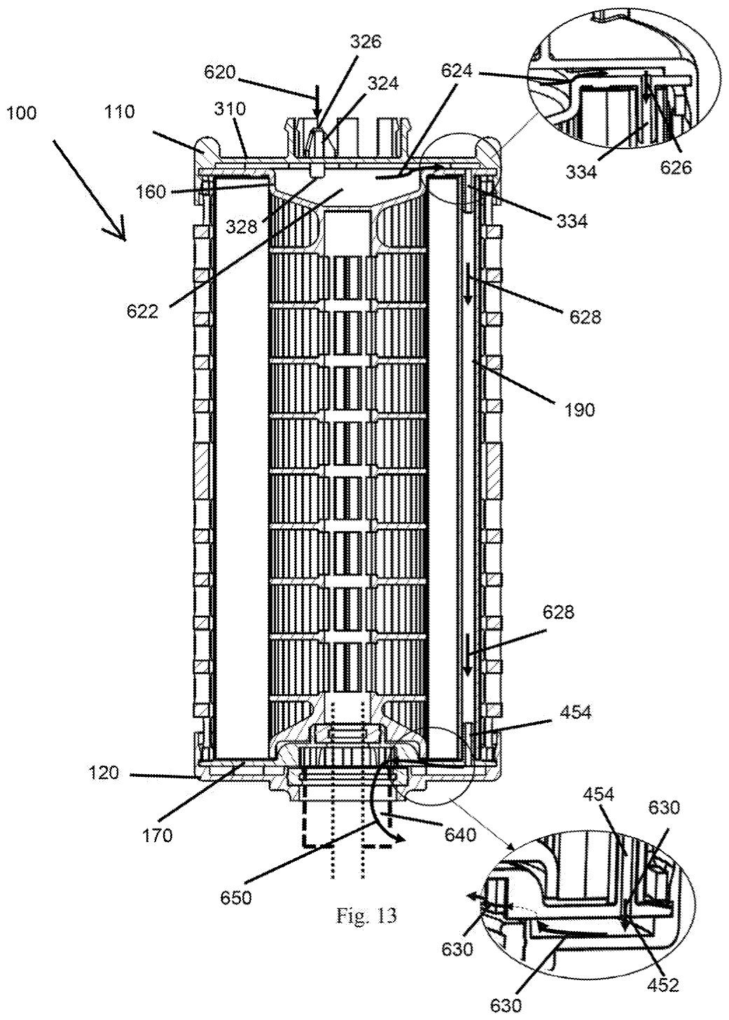

Reference is now made to FIGS. 1-13, which illustrate a filter cartridge 100 constructed and operative in accordance with a preferred embodiment of the present invention. For the purpose of convenience of description, the terms “top” and “bottom” will be used with reference to the filter cartridge 100 as shown in FIGS. 1 and 2, it being understood that in use, the filter cartridge 100 may be oriented in any suitable desired orientation. The filter cartridge 100 is designed to fit inside a filter housing (not shown), which is normally part of a vehicle. Connection portions of the filter housing are shown in FIGS. 12 and 13 for ease of description. It is appreciated that overall, the filter cartridge 100 is generally cylindrical and arranged along an axis 102 and that the terms “axial” and “radial” refer to axis 102.

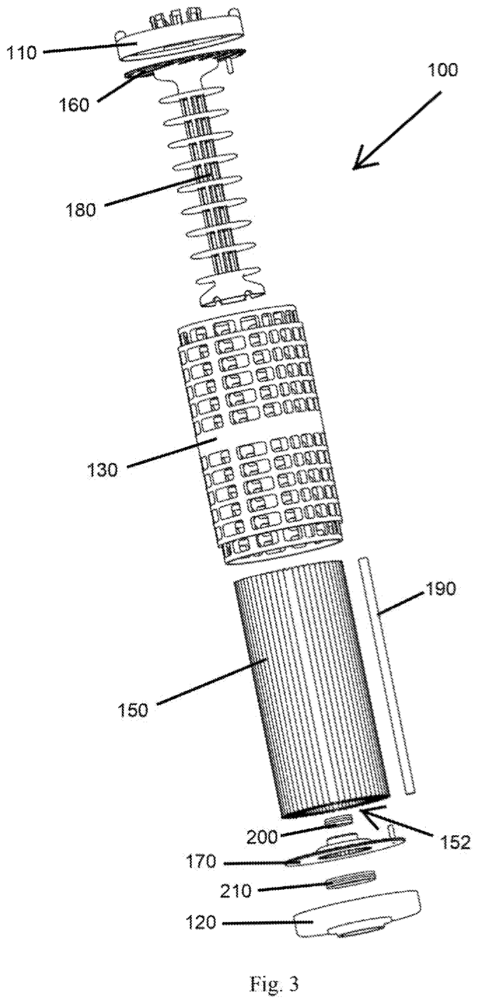

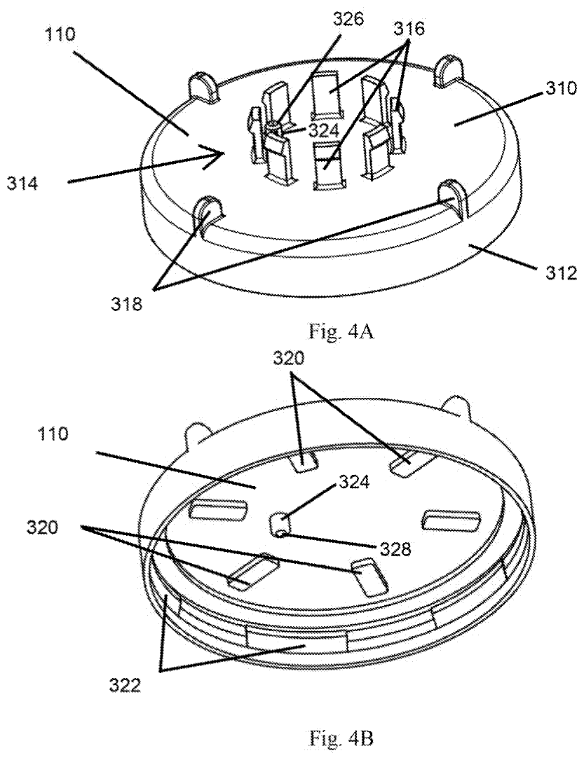

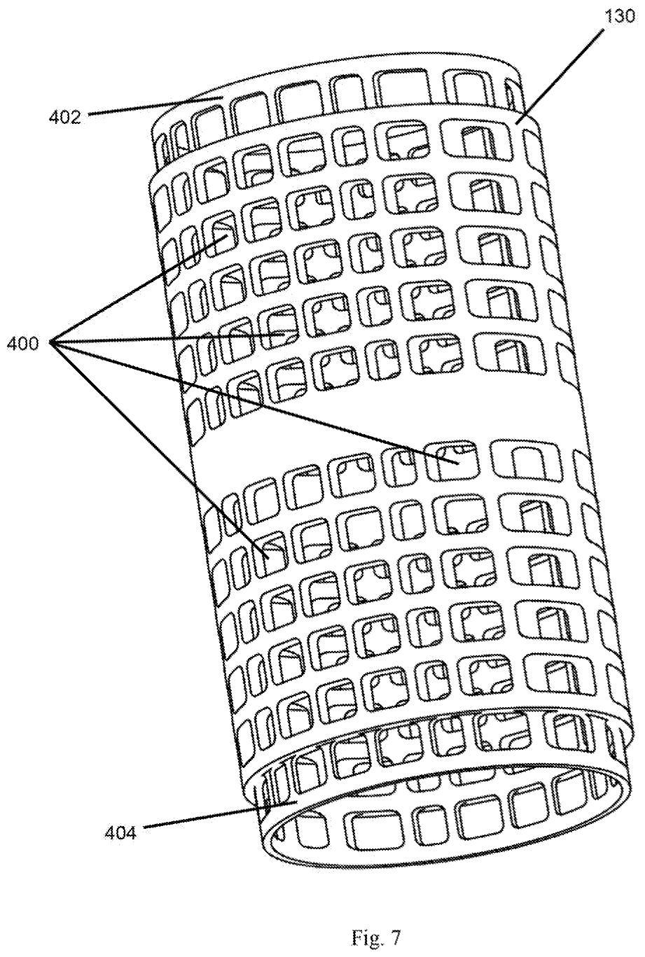

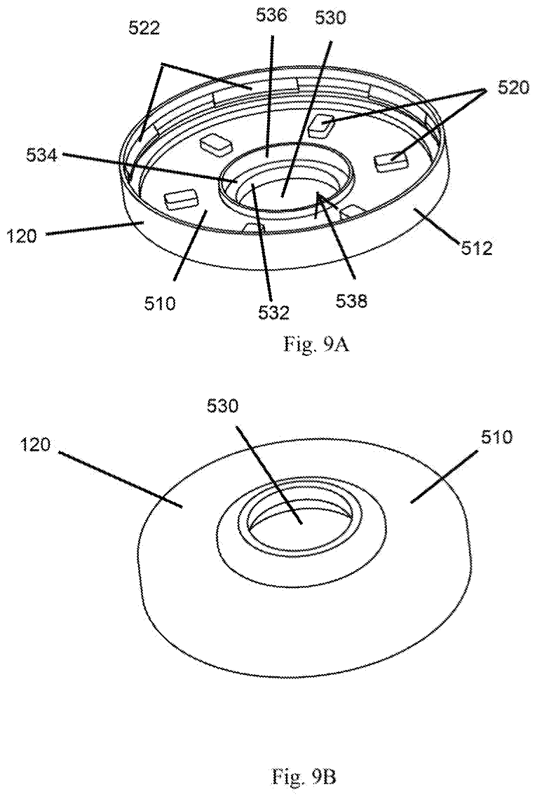

As seen particularly clearly in the exploded view illustration of FIG. 3, filter cartridge 100 preferably includes a cartridge housing symmetrically arranged about axis 102 and including first and second housing end caps respectively designated by reference numerals 110 and 120, which are respectively located at the top and bottom of filter cartridge 100. First housing end cap 110 is illustrated in FIGS. 4A & 4B and second housing end cap 120 is illustrated in FIGS. 9A & 9B. An apertured generally cylindrical housing body 130 is joined at opposite top and bottom ends thereof to the first and second housing end caps 110 and 120. Apertured generally cylindrical housing body 130 is illustrated in FIG. 7.

Filter material, such as any suitable conventional filter material, is arranged as an accordion-like filter medium 150 disposed within the cartridge housing in a generally cylindrical configuration about a central bore 152 and is sealingly adhered, as by heat welding, to first and second filter medium end caps, respectively designated by reference numerals 160 and 170.

A generally cylindrical internal structural member 180 is joined to or integrally formed with the first filter medium end cap 160 and is arranged to extend through central bore 152. Generally cylindrical internal structural member 180 defines an axial filtered fuel flow path therethrough, as will be described hereinbelow.

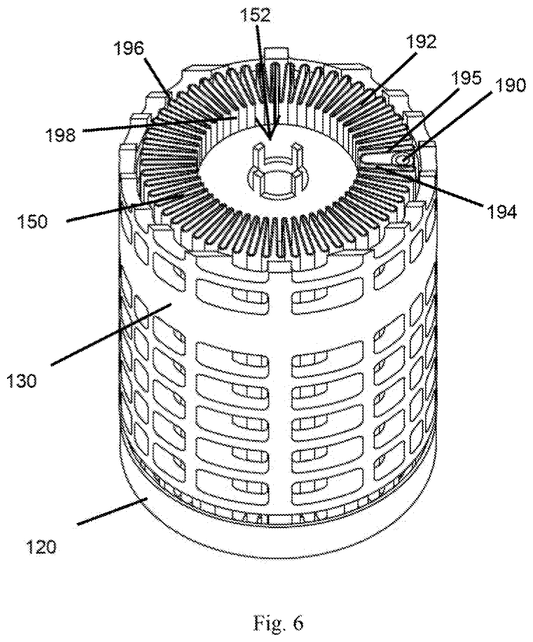

An elongate air venting tube 190, is mounted onto said first and second filter medium end caps 160 and 170 and extends axially interiorly of the cartridge housing but radially exteriorly of filter folded filter material 192 of the filter medium 150, between two adjacent folds 194 and 195 of the accordion-like filter medium 150 and between an outer circumference 196 and an inner circumference 198 thereof, as seen clearly in FIG. 6.

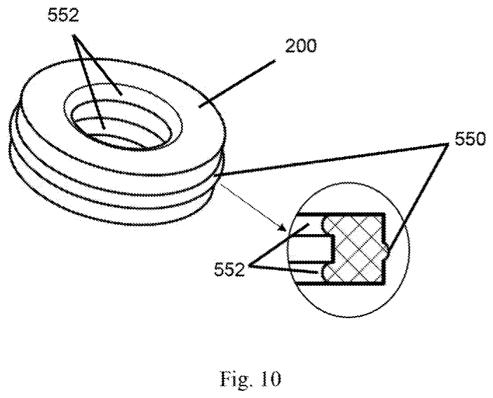

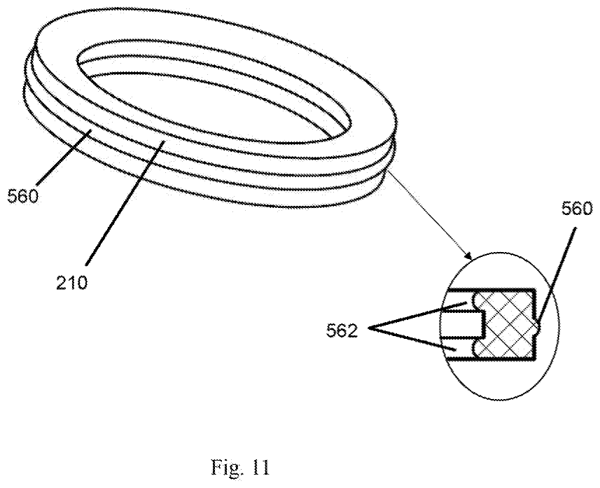

A first gasket 200, shown in FIG. 10, provides sealing between a unfiltered fuel flow path defined by the generally cylindrical internal structural member 180 and the second filter medium end cap 170, and a second gasket 210, shown in FIG. 11, separate and distinct from the first gasket 200, provides sealing between the second filter medium end cap 170 and an air venting conduit (FIG. 13) forming part of the filter housing (not shown).

Reference is now made to FIGS. 4A & 4B, which illustrates a preferred embodiment of the first housing end cap 110. As seen in FIGS. 4A and 4B, first housing end cap 110 is a generally cylindrical element including a generally flat portion 310 and a peripheral rim 312. Formed on a top surface of generally flat portion 310 is a generally circular array 314 of flexible mounting protrusions 316 and four mutually-equally azimuthally spaced positioning protrusions 318. Formed on an underside surface of portion 310 is an array of spacers 320. Formed on a radially-inward surface of rim 312 is an array of snap-fit engagement teeth 322. Extending through portion 310 is an air flow port 324 having an opening 326 above the top surface of portion 310 and a corresponding opening 328 below the underside surface of portion 310.

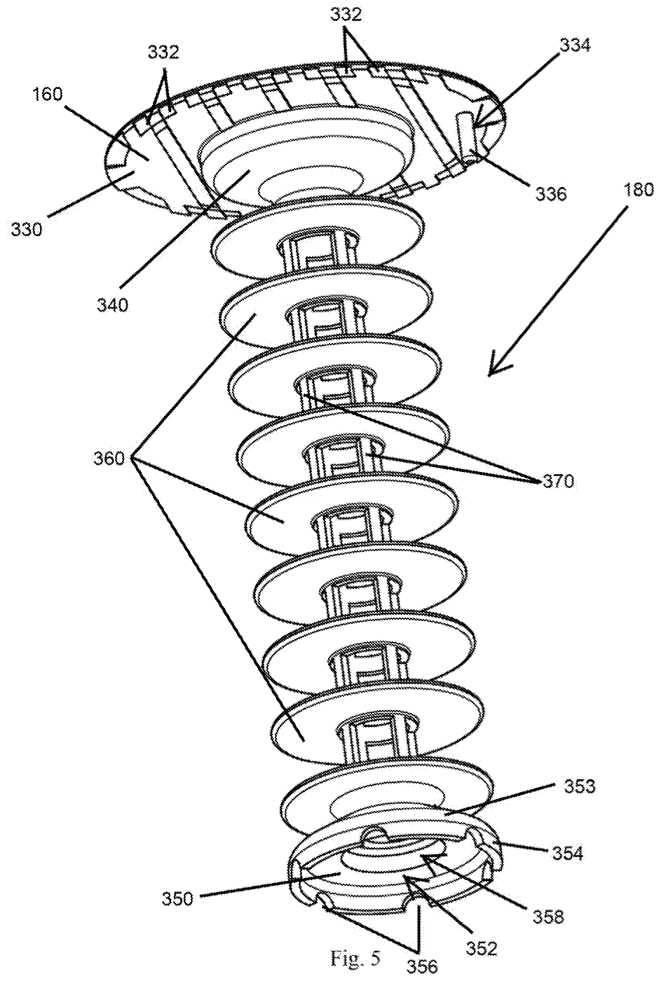

Reference is now made to FIG. 5, which is a simplified pictorial view illustration of generally cylindrical internal structural member 180 typically welded to first filter medium end cap 160 and extending through central bore 152.

As seen in FIG. 5, an inward facing surface 330 of first filter medium end cap 160 is provided with a plurality of recesses 332 for receiving adhesive employed to attach end surfaces of the filter medium 150 thereto. An air flow conduit 334 extends through first filter medium end cap 160 and defines a nipple portion 336 for engagement with elongate air venting tube 190.

Generally cylindrical internal structural member 180 preferably is integrally formed to have a generally dome-shaped top portion 340 and a generally dome-shaped base portion 350. Base portion 350 has a central aperture 352 surrounded by a circular wall 353 and a rim 354 formed with a plurality of azimuthally distributed cut outs 356 to facilitate filtered fuel flow radially outwardly therefrom. A circular recess 358 is formed about aperture 352 and accommodates first gasket 200.

Preferably integrally formed with dome-shaped base portion 350 are a plurality of mutually axially spaced disks 360 which are mutually separated by azimuthally spaced axial posts 370, which define openings for radially inward passage therethrough of unfiltered fuel. Disks 360 and dome-shaped portions 340 and 350 retain the filter medium 150 against radially inward collapse into central bore 152. Above the plurality of mutually axially spaced disks 360 is generally dome-shaped top portion 340.

Reference is now made to FIG. 7, which is a simplified pictorial view illustration of apertured generally cylindrical housing body 130, which, as noted above, is sealingly joined at opposite ends thereof to the first and second housing end caps 110 and 120. Generally cylindrical housing body 130 is preferably integrally formed of plastic and is formed with a multiplicity of axially and radially distributed apertures 400 for permitting egress therethrough of filtered fuel from filter medium 150 (FIGS. 2 and 3). It is noted that generally cylindrical housing body 130 is formed with apertured peripheral recessed portions 402 and 404 at its respective upper and lower ends to accommodate the rim portions of respective housing end caps 110 and 120.

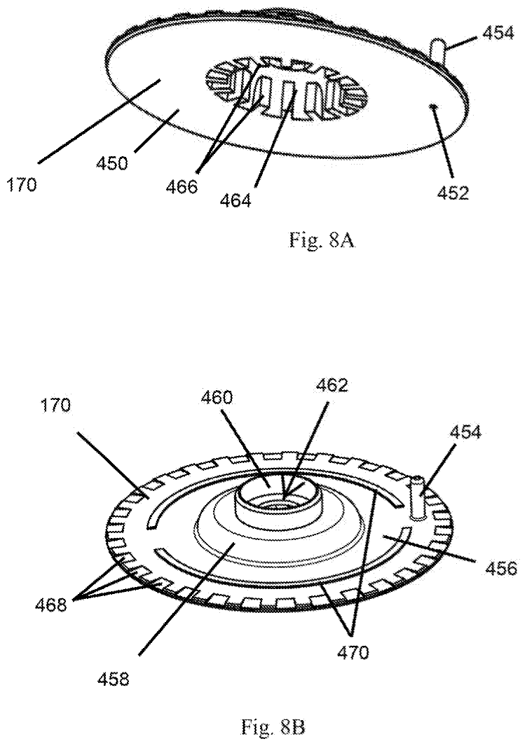

Reference is now made to FIGS. 8A and 8B, which are simplified respective bottom and top view illustrations of second filter medium end cap 170, forming part of the filter cartridge 100 of FIGS. 1-3 and preferably snap-fit onto second housing end cap 120. As seen in FIGS. 8A and 8B, the second filter medium end cap 170 is a generally disk-like element having a generally smooth underside surface 450 having an aperture 452 which communicates with a nipple portion 454 integrally formed therewith on an upper surface 456 thereof. Nipple portion 454, together with nipple portion 336 and elongate air venting tube 190, which are sealingly connected therewith, define an air venting passageway which extends outwardly of the filter material and downstream thereof.

As seen more clearly in FIG. 8B, upper surface 456 defines a central dome like protrusion 458, which is configured to seat within the interior of dome-shaped base portion 350 of generally cylindrical internal structural member 180, a flange 460, which is configured to seat within circular wall 353 of generally cylindrical internal structural member 180 and a unfiltered fuel flow aperture 462. It is seen that underside surface 450 of second filter medium end cap 170 defines a recess 464 which underlies central dome like protrusion 458 and is surrounded by a plurality of azimuthally distributed radially inwardly directed protrusions 466 and is configured for seating therein of first gasket 200. Upper surface 456 of second filter medium end cap 170 preferably is formed with a plurality of azimuthally distributed peripheral recesses 468 for receiving adhesive and thus enhancing adhesion thereto of ends of the filter medium 150 and is also provided with a discontinuous circular protrusion 470 for spacing the ends of the filter medium 150 from the remainder of the upper surface 456.

Reference is now made to FIGS. 9A and 9B, which are respective top and bottom-facing simplified pictorial view illustrations of the second housing end cap 120, forming part of the filter cartridge 100 of FIGS. 1-3. Similarly to first housing end cap 110, the second end cap 120 is a generally cylindrical element including a generally flat portion 510 and a peripheral rim 512. Formed on an underside upward facing surface of portion 510 is an array of spacers 520. Formed on a radially-inward surface of rim 512 is an array of snap-fit engagement teeth 522.

Second housing end cap 120 is formed with a central aperture 530 surrounded by a cylindrical wall 532 which terminates in a ring shaped surface 534. Ring shaped surface 534 terminates in a flange 536. Ring shaped surface 534 and flange 536 together define a recess 538 for seating of gasket 210, which is illustrated in FIG. 11.

Turning now to FIG. 10, it is seen that first gasket 200 is a generally cylindrical element having a circular radially outwardly directed protrusion 550 and a pair of axially spaced radially inwardly directed protrusions 552. As noted above, gasket 200 is seated in recess 464 defined by second filter medium end cap 170.

Turning now to FIG. 11, it is seen that second gasket 210 is a generally cylindrical element having a circular radially outwardly directed protrusion 560 and a pair of axially spaced radially inwardly directed protrusions 562. As noted above, gasket 210 is seated in recess 538 defined by second housing end cap 120.

Reference is now made to FIG. 12, which is a simplified sectional illustration, corresponding generally to FIG. 2 and showing fuel flow through the filter cartridge 100 of FIGS. 1-3 in accordance with a preferred embodiment of the present invention.

As seen in FIG. 12, fuel to be filtered is supplied to the filter cartridge 100 via a conduit 600, which is not part of the filter cartridge 100, but rather is part of the filter housing, as indicated by an arrow 602. Conduit 600 sealingly extends through first gasket 200 and into central bore 152. The fuel passes radially outwardly through filter medium 150, as indicated by arrows 604, and is thus filtered. The filtered fuel flows radially outward of the filter cartridge 100 via apertures 400, as indicated by arrows 606, in apertured generally cylindrical housing body 130 and into the interior of a filter housing, not shown, which is not part of the filter cartridge 100.

Reference is now made to FIG. 13, which is a simplified sectional illustration, corresponding generally to FIG. 2 and showing air flow through the filter cartridge 100 of FIGS. 1-3 in accordance with a preferred embodiment of the present invention.

It is appreciated that air is present in the filter housing (not shown) and in the filter cartridge 100. When fuel fills the filter housing and the filter cartridge 100, air is forced into filter cartridge 100 via air flow port 324 having an air ingress opening 326 above the top surface of generally flat portion 310 of housing end cap 110 and a corresponding air egress opening 328 below the underside surface of portion 310, as indicated by an arrow 620. Air thus flows into a volume 622 defined between housing end cap 110 and filter medium end cap 160 towards air conduit 334, as indicated by an arrow 624. The air is vented from volume 622 via air conduit 334, as indicated by an arrow 626, and passes through elongate air venting tube 190, as indicated by arrows 628, and through aperture 452 which communicates with a nipple portion 454 formed in filter medium end cap 170.

The air then enters a volume defined between filter medium end cap 170 and second housing end cap 120, as indicated by arrows 630, and out of the filter cartridge 100 via an air venting conduit 640, which is not part of the filter cartridge 100, but rather part of the filter housing and is coaxial with fuel supply conduit 600, as indicated by an arrow 650.

It will be appreciated by persons skilled in the art that the present invention is not limited by what has been particularly shown and described hereinabove. Rather the scope of the present invention includes both combinations and sub-combinations of features described hereinabove as well as modifications and variations thereof, which are not in the prior art.

1. A filter cartridge comprising:
a cartridge housing arranged about an axis and including first and second housing end caps and an apertured generally cylindrical housing body joined at opposite ends thereof to said first and second housing end caps;
filter material arranged in an accordion-like filter medium disposed within said cartridge housing in a generally cylindrical configuration about a central bore;
first and second filter medium end caps attached to opposite ends of said filter medium;
a generally cylindrical internal structural member joined to said first filter medium end cap and extending through said central bore; and
an elongate air venting tube mounted onto said first and second filter medium end caps and extending axially interiorly of said cartridge housing but radially exteriorly of said filter material.

2. A filter cartridge according to claim 1 and wherein said accordion-like filter medium defines an outer circumference and an inner circumference and said elongate air venting tube is located radially exteriorly of said filter material, between two adjacent folds of said accordion-like filter medium and between said outer circumference and said inner circumference.

3. A filter cartridge according to claim 1 and wherein said elongate air venting tube is located downstream of said filter material along a fuel flow path therethrough.

4. A filter cartridge according to claim 2 and wherein said elongate air venting tube is located downstream of said filter material along a fuel flow path therethrough.

5. A filter cartridge according to claim 1 and wherein:
said generally cylindrical internal structural member defines a fuel flow path; and
said filter cartridge also comprises:
a first gasket providing sealing of said fuel flow path; and
a second gasket, separate from said first gasket, providing sealing of an air venting flow path.

6. A filter cartridge comprising:
a cartridge housing arranged about an axis and including first and second housing end caps and an apertured generally cylindrical housing body joined at opposite ends thereof to said first and second housing end caps;
an accordion-like filter medium disposed within said cartridge housing in a generally cylindrical configuration about a central bore;
first and second filter medium end caps attached to opposite ends of said filter medium;
a generally cylindrical internal structural member joined to said first filter medium end cap and extending through said central bore, said generally cylindrical internal structural member defining a fuel flow path;
a first gasket providing sealing of said fuel flow path; and
a second gasket, separate from said first gasket, providing sealing of an air venting flow path.

7. A filter cartridge according to claim 6 and wherein:
said generally cylindrical internal structural member comprises a base portion including a circular recess formed therein; and
said circular recess accommodates said first gasket.

8. A filter cartridge according to claim 6 and wherein:
said second housing end cap defines a recess; and
said second gasket is seated in said recess defined in said second housing.

9. A filter cartridge according to claim 6 and wherein:
said first gasket is positioned between said generally cylindrical internal structural member and said second filter medium end cap.

10. A filter cartridge according to claim 6 and wherein:
said second gasket is positioned between said second filter medium end cap and said second housing end cap.

11. A filter cartridge comprising:
a cartridge housing arranged about an axis and including first and second housing end caps and an apertured generally cylindrical housing body joined at opposite ends thereof to said first and second housing end caps;
filter material arranged in an accordion-like filter medium disposed within said cartridge housing in a generally cylindrical configuration about a central bore;
first and second filter medium end caps attached to opposite ends of said filter medium;
a generally cylindrical internal structural member joined to said first filter medium end cap and extending through said central bore, said generally cylindrical internal structural member defining a fuel flow path;
an elongate air venting tube mounted onto said first and second filter medium end caps and extending axially interiorly of said cartridge housing but radially exteriorly of said filter material;
a first gasket providing sealing of said fuel flow path; and
a second gasket, separate from said first gasket, providing sealing of an air venting flow path coupled to said elongate air venting tube.

12. A filter cartridge according to claim 11 and wherein said accordion-like filter medium defines an outer circumference and an inner circumference and said elongate air venting tube is located radially exteriorly of said filter material, between two adjacent folds of said accordion-like filter medium and between said outer circumference and said inner circumference.

13. A filter cartridge according to claim 11 and wherein said elongate air venting tube is located downstream of said filter material along a fuel flow path therethrough.

14. A filter cartridge according to claim 12 and wherein said elongate air venting tube is located downstream of said filter material along a fuel flow path therethrough.

15. A filter cartridge according to claim 11 and wherein:
said generally cylindrical internal structural member comprises a base portion including a circular recess formed therein; and
said circular recess accommodates said first gasket.

16. A filter cartridge according to claim 11 and wherein:
said second housing end cap defines a recess; and
said second gasket is seated in said recess defined in said second housing.

17. A filter cartridge according to claim 11 and wherein:
said first gasket is positioned between said generally cylindrical internal structural member and said second filter medium end cap.

18. A filter cartridge according to claim 11 and wherein:
said second gasket is positioned between said second filter medium end cap and said second housing end cap.
